(19) United States
(12) Patent Application Publication
(10) Pub. No.: US 2025/0230561 A1
(43) Pub. Date: Jul. 17, 2025

(54) ELECTROCHEMICAL SYSTEM WITH PRESSURE EQUALIZATION PLATE

(71) Applicant: Reinz-Dichtungs-GmbH, Neu-Ulm (DE)

(72) Inventors: Robert BLERSCH, Baltringen (DE); Thomas STÖHR, Laupheim (DE); Johannes KÖBELE, Ulm (DE); Tim DANIEL, Ulm (DE)

(21) Appl. No.: 19/015,415

(22) Filed: Jan. 9, 2025

(30) Foreign Application Priority Data
Jan. 12, 2024 (DE) 20 2024 100 156.7

(51) Int. Cl. C25B 9/77; C25B 15/08; H01M 8/248

(52) U.S. Cl. CPC C25B 9/77; C25B 15/08; H01M 8/248

(57) ABSTRACT

The present disclosure relates to an electrochemical system, in particular an electrochemical system having a stack comprising at least a plurality of electrochemical cells and separator plates, at least one end plate assembly, and at least one pressure equalization plate arranged between the stack and the end plate assembly, wherein a side of the end plate assembly that faces the stack has at least a first recess and a first solid region of the pressure equalization plate lies opposite this first recess.

### CROSS REFERENCE TO RELATED APPLICATION

This application claims priority to German Utility Model Application No. 20 2024 100 156.7, entitled “ELECTROCHEMICAL SYSTEM WITH PRESSURE EQUALIZATION PLATE”, filed Jan. 12, 2024. The entire contents of the above-identified application is hereby incorporated by reference for all purposes.

### TECHNICAL FIELD

The present disclosure relates to an electrochemical system, in particular a fuel cell system or an electrolyzer system.

### BACKGROUND AND SUMMARY

Existing electrochemical systems typically comprise a stack of a number of different components that are stacked on top of each other along a stack axis. The stack can alternatively also be referred to as a fuel cell stack. A certain component sequence can occur several times within the stack. For example, a defined component sequence can be repeatedly present in succession within the stack. The electrochemical system disclosed here can also have such a stack. An example of an electrochemical system with a stacked configuration can be found in DE 20 2018 105 617 U1 and in particular in FIG. 1.

The stack is typically held between so-called end plate assemblies. These can form the outermost layers of an electrochemical system and, for example, have connections for electricity and/or for supplying and/or discharging fluids. The end plate assemblies are supported by the stack and can, in particular, rest directly against it. High contact forces usually occur, as the electrochemical system is typically mechanically braced. In particular, the end plate assemblies can be pressed against the stack in a predetermined manner, that is clamp the stack between them.

This clamping is generally used to press the components of the stack together in a defined manner. This may be necessary in particular in order to pretension and/or deform sealing elements, for example sealing beads, or other elements to be pretensioned in a defined manner within the stack.

It has been shown that the functionality of pretensioned elements is not always reliably achieved with existing solutions. This can impair the functionality and in particular the operating efficiency of the electrochemical system, for example as a result of insufficiently pronounced sealing effects.

The object is therefore to provide an electrochemical system with increased operational reliability.

This object is at least partially achieved by the subject-matter of described in this description and in the figures.

Accordingly, an electrochemical system is proposed with:
a stack comprising at least a plurality of electrochemical cells and separator plates;
at least one end plate assembly,
at least one pressure equalization plate located between the stack and the end plate assembly, wherein a side of the end plate assembly that faces the stack has at least a first recess and a first solid region of the pressure equalization plate lies opposite this first recess.

According to the present disclosure, it was recognized that the functioning of elements of the stack to be pretensioned can be impaired in particular by the fact that the stack cannot be tensioned in a desired manner. This can result, for example, from the fact that contact forces and, in particular, compressive forces to be introduced into the stack are not defined and/or cannot be generated locally and uniformly. Instead, unintentional local deviations in these forces can occur, so that the stack is locally compressed less strongly, for example. In these local regions, for example, it may no longer be possible to reliably achieve effective sealing.

It was further recognized in accordance with the present disclosure that such pressure irregularities may result from an uneven support between the stack and at least one of the end plate assemblies. If, for example, a flat support and/or flat contact between these elements is locally interrupted, the above-described local deviations of the compression or tension forces can occur in this interrupted region.

To at least partially compensate for these recognized causes, the provision of a pressure equalization plate is proposed here, which, for example, at least partially covers and/or bridges a first recess in the end plate assembly from the perspective of the stack. Despite the recesses in the end plate assembly described above, the pressure equalization plate can thus enable uniform surface contact and/or surface support between the stack and the end plate assembly.

The components of the stack can be stacked on top of each other along a stack axis. They can extend orthogonally to this stack axis. The height of the stack can be measured along the stack axis. The end plate assembly and/or the pressure equalization plate can also extend orthogonally to the stack axis.

The electrochemical system may also include another end plate assembly positioned near a side of the stack that is opposite the side positioned near the aforementioned end plate assembly. In other words, the electrochemical system may have two end plate assemblies and these may be located at remote sides or ends of the stack. A pressure equalization plate of the type disclosed herein may also be provided between this further, thus second, end plate assembly and the stack.

The stack may include all components of the electrochemical system located between two end plate assemblies, with the exception of the at least one pressure equalization plate.

The separator plates can be connected in pairs to form bipolar plates. Additionally or alternatively, single-layer separator plates can be provided; these can, for example in an electrolyzer, take over the function of a bipolar plate directly, e.g. without an additional second layer. Separator plates at a bottom and/or top position in the stack can form so-called unipolar plates. The unipolar plates can differ from the other bipolar plates, for example, in their fluid guidance structure. The unipolar plates can also be one or two layered. Furthermore, it is possible to provide dummy or tempering cells at or adjacent to the end of a stack which are electrochemically inactive but allow fluid to flow in the direction of the stack. These dummy or tempering cells can, but do not have to, at least serve to temper the stack or the components adjacent to them.

An electrochemical cell can comprise a MEA (membrane electrode assembly) and at least one gas diffusion layer, for example a gas diffusion layer on each side of the MEA.

The end plate assembly can, for example, include or accommodate channels for the supply and/or removal of reactants, reaction products and/or coolants. Additionally or alternatively, a current collector, a diversion section connected thereto and/or other components, such as fastening elements or mechanical interfaces for connecting to an external support structure, may be included or at least partially included in the end plate assembly. Additionally or alternatively, straps, screws, bolts or other tensioning means used to tension the stack can be attached or fastened to the end plate assembly. The end plate assembly can be spaced from the stack and, more precisely, from an outermost component of the stack when viewed along the stack axis, at least in certain regions, by the pressure equalization plate. The end plate assembly can be supported on the stack via the pressure equalization plate.

The pressure equalization plate can optionally have recesses, for example in the form of openings. Solid regions of the pressure equalization plate can be free of openings and have a continuous plate material, for example. The pressure equalization plate can, for example, comprise a metallic material, for example sheet metal. Alternatively, according to the following embodiments, it can be made of an electrically insulating material or additionally coated with such a material. The pressure equalization plate can face the first recess of the end plate assembly in such a way that it at least partially covers, spans or bridges it, especially from the perspective of the stack. Facing in this context for example means to oppose one another with respect to a plane orthogonal to the stack axis. Optionally, the stacking axis or an axis parallel to it can intersect both the recess and the pressure equalization plate.

The pressure equalization plate can rest against the stack at least in some regions, for example against an outermost separator plate of the stack, which can form at least part of a unipolar plate. The pressure equalization plate can at least partially rest against the side of the end plate assembly that faces the stack.

The pressure equalization plate can be smaller than the separator plates of the stack and can be smaller at least than the outermost separator plate of the stack. For example, it can be no more than 80% as large or no more than 60% as large. The dimensioning ratio of the pressure equalization plate and separator plates can be determined, for example, on the basis of the area sizes, optionally as an area size ratio, of the pressure equalization plate and the separator plates that face each other and/or abut each other, for example at least the outermost separator plate in the stacking direction or a unipolar plate. The area may be considered either as the entire area spanned by the respective plate, thus defined by the outer contours of the plate disregarding recessed areas or the like, or as the actual area after deduction of the recessed areas. In addition or alternatively, one embodiment provides that a maximum extension of the pressure equalization plate in a direction transverse to the stack axis is less, for example at least 5% or at least 20% less, than a corresponding maximum extension of the separator plates of the stack and optionally of at least the outermost separator plate. In other words, the pressure equalization plate may not extend as far outwards as the separator plates.

For example, the pressure equalization plate can remain at a distance from an outermost edge of the separator plates, for example from at least the outermost separator plate, at least in sections, or all the way around. This distance can in turn run transverse to the stack axis and/or be present in an orthogonal projection of the pressure equalization plate and the separator plates along the stack axis onto a common plane.

The pressure equalizing effect of the pressure equalizing plate results from its arrangement opposite the first recess. This allows the contact conditions with the stack and for example with its outermost separator plate to be adjusted locally. Otherwise, the contact conditions in the region of the first recess would deviate significantly locally. More specifically, in this region the structural support of the stack would be interrupted by the end plate assembly, which would result in a locally greatly reduced transfer of compressive force into the stack. The pressure equalization plate at least partially compensates for such locally varying pressure force application.

According to one embodiment, the pressure equalization plate completely covers the first recess. This means that the pressure-equalization effect can be particularly comprehensive.

According to one embodiment, the pressure equalization plate rests against the end plate assembly and/or against the stack, for example against an outermost separator plate thereof. If the pressure equalization plate is attached to both the end plate assembly and the stack, as provided for in embodiments, further intermediate components can be avoided, and a compact system design can be achieved. For example, the pressure equalization plate may not be in contact with any components other than the end plate assembly and the stack.

According to a further embodiment, the at least one first recess-and/or all recesses of any plurality of recesses considered together-occupies/occupy a proportion of less than 50%, optionally less than 30% and optionally less than 20% of an area of the side of the end plate assembly that faces the stack. This emphasizes that the recess can be locally delimited.

According to a further embodiment, the first solid region of the pressure equalization plate faces a region of the stack comprising at least one of the following sections:
at least one section of at least one sealing element, for example a sealing bead, of at least one separator plate for sealing a region of the separator plate;
at least one section of at least one support element of at least one separator plate and/or of another support structure for at least partially supporting the separator plate and/or for reducing the load on a sealing element of this separator plate, for example in the event of a crash or impact.

In this case, the facing manner can for example comprise an at least indirect succession along a stacking direction. Optionally, the facing manner may involve the corresponding regions or sections being arranged one above the other and/or overlapping each other when viewed in the stacking direction. For example, the aforementioned regions can be positioned opposite each other in such a way that they are each intersected by a stacking axis or by an axis parallel to the stacking axis.

The support elements, which can optionally be support beads or other support structures, can serve as deformation limiters, optionally also during expected normal loads during operation and/or already during compressing of the stack. Consequently, they do not only provide their deformation-limiting effect in the event of a crash, although this can be provided for in other embodiments. They can limit deformations of a separator plate under pressure, at least in certain regions, for example by providing support and/or contact surfaces to neighboring components. This allows a separator plate to be stiffened locally.

An additional or alternative section, which can face the solid region of the pressure equalization plate, can be a section of a barrier element that can specifically reduce or prevent at least one media flow along a separator plate, at least in certain regions. For example, the barrier element can specifically influence the flow of a reaction medium. For example, the flow of a reaction medium past an active region of the separator plate can be specifically reduced or prevented by these barrier elements. Such barrier elements can be formed in one piece with the separator plate and optionally molded into it, for example by an embossing process. An example of barrier elements, as can also be provided in the solution disclosed here, can be found in EP 3 631 884 A1.

The barrier elements can be supported on neighboring components and optionally on a neighboring separator plate. However, they can also be situated at a distance from neighboring components and optionally from a neighboring separator plate, e.g. due to a reduction of their height.

By extending the pressure equalization plate opposite any of the above-mentioned regions, sections and elements, pressure forces can be introduced into them in a locally uniformly distributed manner.

According to one embodiment, the pressure equalization plate is free of sealing beads or other sealing elements. The pressure equalization plate can therefore not be set up specifically for fluidic sealing and/or cannot have any sealing elements that create a specific fluidic sealing effect when in contact with an adjacent component. This simplifies the design of the pressure equalization plate accordingly.

According to a further embodiment, the pressure equalization plate has a thickness of at least 0.075 mm and/or up to 2 mm. It has been shown that the desired pressure equalization can be reliably achieved without excessively increasing the resulting overall height of the electrochemical system.

According to a further embodiment, the thickness of the pressure equalization plate, which can be measured along the stacking direction and/or along a stack height, for example, is constant. Alternatively, it can be constant at least within 90% of a solid surface portion of the pressure equalization plate. This can simplify the manufacture of the pressure equalization plate and/or reduce its contribution to the overall height of the electrochemical system. Solid in the context of this document comprises that the pressure equalization plate throughout consists of material, thus is not hollow.

According to a further embodiment, the pressure equalization plate is de-energized, for example without current, during operation of the electrochemical system. This means, for example, that the requirements for the pressure equalization plate and/or its installation in the electrochemical system can be reduced due to its de-energized nature, e.g. no special preventive measures against corrosion are necessary.

According to a further embodiment, the pressure equalization plate comprises a plastic material and/or a metallic material. Alternatively or additionally, the pressure equalization plate can be electrically insulated, for example by means of an electrically insulating coating. In other words, the pressure equalization plate can generally be electrically insulated. In this case too, the pressure equalization plate is therefore de-energized during operation of the electrochemical system.

Due to its electrically insulating properties, the pressure equalization plate can increase the operational safety of the electrochemical system. For example, it is known that current-carrying components are installed on or at least in the vicinity of end plate assemblies and therefore also in the vicinity of the pressure equalization plate. This can be a current collector, for example. An electrically insulating design of the pressure equalization plate can reduce the risk of short circuits and thus increase operational safety. For example, this allows the pressure equalization plate to be closer to and/or even in contact with current-carrying components. This can be used to provide the pressure equalizing effect of the pressure equalizing plate close to current-carrying components.

According to a further embodiment, the pressure equalization plate extends around a central recess in a frame-like manner. The central recess can be the largest recess and/or the only recess within the pressure equalization plate. It can take up at least 20%, at least 40% or even at least 50% of a base region of the pressure equalization plate, wherein this total region can be defined for example as the sum of the surface regions of the recess and the solid regions of the pressure equalization plate. For example, the base area can be spanned by the outer edges of the pressure equalization plate. The central recess can specifically provide a free space in order to provide installation space for certain components, such as a current collector, within the pressure equalization plate. Alternatively, several pressure equalization plates can also be arranged leaving a central recess, which together form sections of a frame shape, for example.

According to a further embodiment, the central recess is located opposite at least part of a region of the stack in which the electrochemically active regions of the cells are stacked on top of one another. These electrochemically active regions can, for example, be regions in which an MEA and/or gas diffusion layer mentioned above is/are located opposite a so-called flow field of a separator plate. Figuratively speaking, the central recess can frame at least a portion of the electrochemically active regions, for example when viewed from above and/or along the stack axis.

According to a further embodiment, the at least one first recess of the end plate assembly is designed as:
a counterbore, or as another recess, for receiving a screw head or a section of another fastening element; or
a receiving region for a diversion section.

Such counterbores and fastening elements can be provided on the side of the end plate assembly that faces the stack in order to fasten further elements that are to be arranged on a side of the end plate assembly that faces away from the stack.

The, for example groove-shaped, receiving region for the diversion section can define a recess with a larger surface region than any counterbores, into which for example a flat diversion section can be inserted. The diversion section can be configured to divert current from a current collector, for example to components located outside the stack. The diversion section can extend parallel to the components of the stack and/or to the pressure equalization plate and/or to the end plate assembly and/or orthogonal to the stack axis. It can be connected to a current collector, for example a flat current collector, in a current-conducting manner and optionally can be formed integrally with it. It can cover a significantly smaller area than the current collector, e.g. less than 50% or less than 10% of the area of the current collector. In each case, a surface of the diversion section and the current collector that is oriented orthogonally to the stacking axis can be considered.

According to a further embodiment, the pressure equalization plate has at least one recess, which is optionally different from an optionally provided central recess. This recess can face a recess in at least one component of the stack, e.g. a recess in at least one separator plate. Alternatively, the recess can be provided in an electrochemical cell, and optionally can be provided in all electrochemical cells in the same way. For example, the recess can be used to allow fluid to pass through the stack. For example, the recess can be a so-called manifold, as is common in separator plates in the prior art. The recess of the pressure equalization plate can be located specifically opposite such a recess for example, a manifold, so as not to impede fluid exchange with the end plate assembly. This fluid exchange can instead take place through the recess in the pressure equalization plate. The sealing of the recess can be ascertained by the sealing elements in the adjacent elements, thus the end plate assembly and the separator plates, it is not necessary that a sealing element is provided in the pressure equalization plate itself.

Alternatively or additionally, the recess of the pressure equalization plate may face a second recess of the end plate assembly, for example wherein the second recess is formed as a channel opening for supplying fluid into the stack and/or discharging fluid from the stack. The channel opening can be provided for the fluid exchange described above with the manifolds of the stack and, for example, aligned with these. In this case, too, the pressure equalization plate can be deliberately opened locally so as not to impede this fluid exchange.

In summary, it can therefore be provided that the pressure equalization plate optionally has recesses, for example in the form of openings, in regions in which it faces regions of the stack and/or the end plate assembly that do not have increased requirements with regard to a defined application of compressive force. Instead, opposite such regions and as described in the examples above, a recess in the pressure equalization plate may improve the functionality of the electrochemical system and/or be required to ensure this functionality.

Exemplary embodiments of the present disclosure will be explained below with reference to the accompanying schematic figures. The same reference symbols can be used for identical or comparable features across all figures.

### BRIEF DESCRIPTION OF THE FIGURES

FIG. 1 is a perspective view of an electrochemical system according to an example embodiment.

FIG. 2 is a partial sectional view of an electrochemical system according to an example of the prior art.

FIG. 3 is a partial sectional view analogous to FIG. 2, but of the electrochemical system according to the present disclosure shown in FIG. 1.

FIG. 4 shows views of an end plate assembly and an outermost separator plate in the stack of the electrochemical system of FIGS. 1 and 3.

FIG. 5 is a view similar to FIG. 4, but with an additional pressure equalization plate shown.

FIG. 6 is a view analogous to FIG. 4, but with an additional pressure equalization plate shown according to a further embodiment.

FIG. 7 is a view analogous to FIG. 3 relating to a further embodiment.

FIG. 8 is a view analogous to FIG. 7 relating to yet another embodiment.

### DETAILED DESCRIPTION

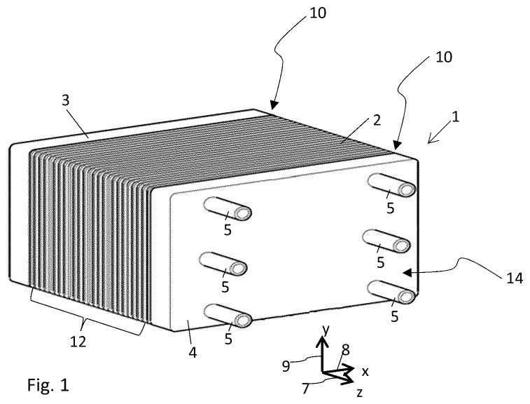

FIG. 1 shows an electrochemical system 1 according to the present disclosure with a stack 12 with a plurality of identical bipolar plates 2, which are stacked along a z-axis 7 and—possibly together with unipolar plates and/or dummy or tempering cells—are clamped between two end plate assemblies 3, 4. The bipolar plates 2 here each comprise two interconnected individual plates, also referred to as separator plates in this document. The z-axis 7 defines a stacking direction. A stack axis that is not entered separately runs parallel to the z-axis 7 and, for example, through a geometric center of the stack 12.

In the present example, the system 1 is a fuel cell stack. Each two adjacent bipolar plates 2 of the stack 12 enclose an electrochemical cell between them, which is used, for example, to convert chemical energy into electrical energy. The stack 12 can also contain unipolar plates and/or dummy or tempering cells. The electrochemical cells usually each comprise a membrane electrode assembly (MEA) as well as gas diffusion layers (GDL). In alternative embodiments, the system 1 can be designed as an electrolyzer, compressor or redox flow battery, for example. Bipolar plates can also be used in these electrochemical systems 1. The structure of these bipolar plates can essentially correspond to the structure of the bipolar plates 2 described in more detail here, even if the media carried on or through the bipolar plates may differ. They can also be single-layer bipolar plates only.

The z-axis 7, together with an x-axis 8 and a y-axis 9, spans a right-handed Cartesian coordinate system. The end plate assembly 4 has a plate-shaped component and/or a plate-shaped region 14 and a plurality of media connections 5. Media, for example fluids, can be supplied to system 1 via these and media can be discharged from system 1 via these. These media, suppliable to system 1 and dischargeable out of system 1, may, e.g., comprise fuels like molecular hydrogen or methanol, reaction gases like air or oxygen, reaction products like water vapor, or coolants like water and/or glycol.

The positions of pressure equalization plates 10 are also marked in FIG. 1. These are each arranged between the stack 12 and a side of one of the end plate assemblies 3, 4 facing this stack 12.

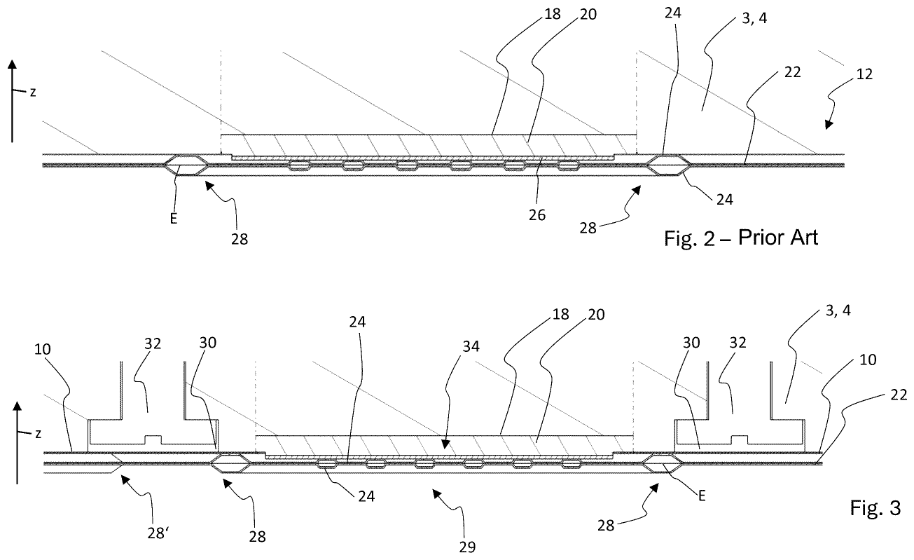

FIGS. 2 and 3 are schematic sectional views, with a sectional plane that runs, for example, perpendicular to an X-Y plane as shown in FIG. 1. FIG. 2 shows an example of the prior art without pressure equalization plates 10. FIG. 3, on the other hand, shows a sectional view through the example embodiment of FIG. 1 according to the present disclosure with a pressure equalization plate 10. FIGS. 2 and 3 each show a part of an end plate assembly 3, 4 and of two outermost separator plates 24 of the stack 12 that are adjacent to and/or abutting thereon. The dash-dot lines indicate that a region between the dash-dot lines is shown schematically shortened and/or merely symbolically and can, for example, be significantly wider horizontally.

FIG. 2 shows a region of an end plate assembly 3, 4 which has a recess 18 for receiving a conventional plate-shaped current collector 20. The current collector 20 faces the stack 12, of which only an outermost two-layer unipolar plate 22 is shown. This comprises two separator plates 24 that are firmly connected to each other and, for example, welded together. In a manner known per se, the separator plates 24 are sheet metal plates in which various structural elements are molded and, for example, embossed. The separator plates 24 extend essentially parallel to each other. The bipolar plates 2 of the stack 12, which are not shown, can be configured essentially in the same way as the unipolar plates 22 shown, but differ from these in that they have a fluid guide along both outer sides of the separator plate 24, including all the additional structural features required for this.

At least one GDL 26 is arranged between the current collector 18 and the unipolar plate 22. The at least one GDL can be installed here alone or together with a membrane, which is optionally designed without electrodes and catalyst layer. The number of GDLs depends for example on the installation space available or to be filled.

Apart from the recess 18 for the current collector 20, the side of the end plate assembly 3, 4 facing the stack 12 is flat. It contacts the unipolar plate 22 in the region of sealing beads 28, which protrude from a contact plane E of the separator plates 24. When the stack 12 is tensioned, pressure forces should be exerted on these sealing beads 28 in order to achieve a defined deformation and the associated defined sealing effect. It should be noted that the other bipolar plates 2 of the stack 12, which are not shown, have sealing beads 28 at similar positions, to which compressive forces from neighboring plates in the stack 12 are transmitted.

In the example shown in FIG. 2, the introduction of compressive force into the stack 12 is essentially without problems due to the continuous flat shape of the side of the end plate assembly 3, 4 that transmits the compressive force in this direction.

FIG. 3, on the other hand, assumes that the side of the end plate assembly 3, 4 that transmits the compressive force is uneven. For example, first recesses 30 are provided there, at least in sections, for receiving fastening elements 32. In the case shown, the recesses 30 are each counterbores for receiving a screw head.

In the region of these recesses 30, an opposite section of the unipolar plate 22, as well as of all bipolar plates 2 of the stack which are not shown here, receives a locally interrupted structural support from the end plate assembly 3, 4. This makes it more difficult to apply defined compressive forces when the stack 12 is clamped. For example, FIG. 3 shows that at least edge regions of two sealing beads 28, which are positioned near an electrochemically active region 29 of the stack 12, lie opposite the recesses 30 or, figuratively speaking, overlap with them. Also shown is a support element 28′, which can be formed, for example, in an outer region of the unipolar plate 22 and analogously in an outer region of the other bipolar plates 2 of the stack that are not shown here. For example, such a support element 28′ can encompass the corresponding plates. This support element 28′ lies opposite the left-hand recess 30 in FIG. 3 to an even greater extent than the sealing bead 28.

The example embodiment according to FIG. 3 provides for a pressure equalization plate 10 to be arranged between the pressure force-transmitting side of the end plate assembly 3, 4 and the stack 12 or its outermost unipolar plate 22 in such a way that the recesses 30 are at least partially and, in the example shown, completely covered. This also provides a flat contact surface for the stack 12 in the region of the recesses 30, which enables a local equalization of the pressure force transmission. For example, all sealing beads 28 and support elements 28′ can be subjected to compressive forces in a uniform or planar manner essentially analogous to the example in FIG. 2 and thus can be compressed in a defined manner.

The sectional view of FIG. 3 also shows that the pressure equalization plate 10 has a central recess 34, which is surrounded on both sides by two solid sections of the pressure equalization plate 10. These solid sections are each marked with the reference sign 10. The central recess 34 is located opposite the current collector 20 in such a way that it can be contacted through the central recess 34. Optionally, the current collector 20 extends partially through the central recess 34, as shown.

In the context of the present disclosure, the term “solid” section does not exclude the possibility that such a section may be at least locally interrupted and, for example, perforated. However, such hypothetical openings are optionally significantly smaller than the central recess 34. For example, on average they each have a maximum surface area of 10% of the central recess 34. Alternatively or additionally, a proportion of non-perforated regions of the solid section optionally significantly outweighs a cumulative proportion of the hypothetical openings, e.g. by more than double or more than four times.

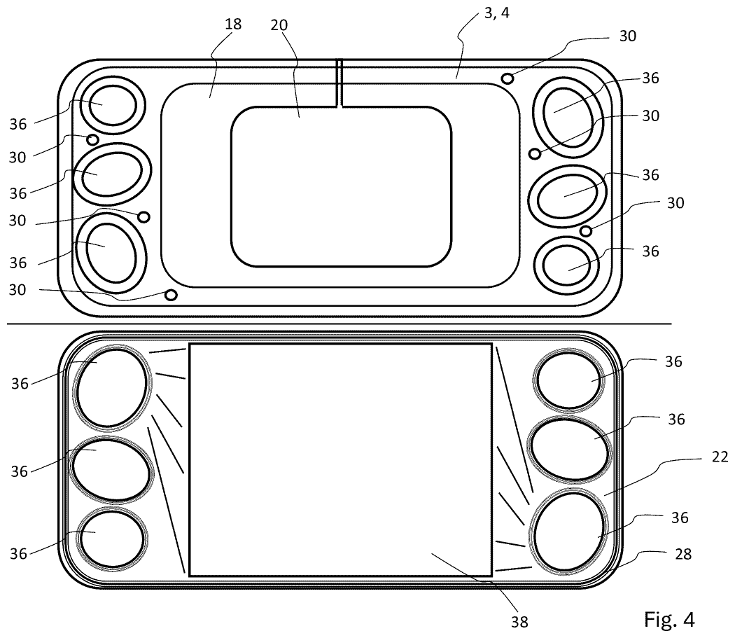

The upper part of FIG. 4 shows a view of the side of the end plate assembly 3, 4 from FIG. 3 that transmits the compressive force. In its lower part, FIG. 4 shows a view of the outer side of the unipolar plate 22 of FIG. 3 opposite the end plate assembly 3, 4. Referring first to the end plate assembly 3, 4, the recess 18 for the current collector 20 is again shown. The recess 18 is completely surrounded by a flat region of the end plate assembly 3, 4. Also shown are schematic positions of recesses 30 in the form of counterbores, as explained with reference to FIG. 3. The number, size and position of these recesses 30 are merely exemplary. Furthermore, the end plate assembly 3, 4 comprises manifolds 36, which are fluid-conductingly connected to and/or surrounded by the media connections 5 of FIG. 1. These manifolds 36, each forming or comprising channel openings within the meaning of the present disclosure, are not included in the schematic view shown in FIG. 3.

The unipolar plate 22, which is generally similar to examples of the prior art, also includes a plurality of manifolds 36. In the stacked configuration shown in FIG. 1 and FIG. 3, these are each arranged opposite one of the manifolds 36 of the end plate assembly 3, 4. Also shown is a flow field 38 of the unipolar plate 22, which is located in an electrochemically active region of the stack 12 and through which reaction medium is passed between two of the manifolds 36 positioned on different sides of the flow field 38. The circumferential outer sealing bead 28 of FIG. 3 is also shown, whereas the schematic view of FIG. 4 does not show the other support elements 28′ of FIG. 3, which are arranged close to the outer edge.

The schematic view of FIG. 4 shows that in the stacked configuration at least the uppermost and lowermost recess 30 of the end plate assembly 3, 4 are opposite the circumferential sealing bead 28 or at least positioned very close to it, see also FIG. 3. Other of the recesses 30 or additional recesses 30 not shown, on the other hand, can lie opposite the support elements 28′ that are not shown in FIG. 4. Without the pressure equalization plate 10 disclosed here, each of the recesses 30 could cause a locally uneven introduction of compressive force into the stack 12 and thus reduce the homogeneity of a local pressure distribution.

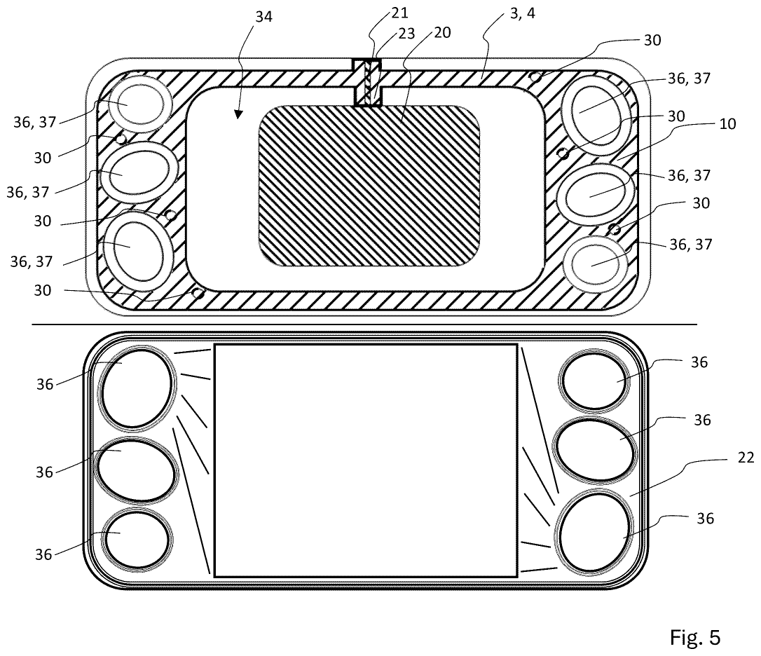

FIG. 5 corresponds to the illustration in FIG. 4, with the difference that in this case the pressure equalization plate 10 is shown in a state in contact with the end plate assembly 3, 4. Solid regions of the pressure equalization plate 10 are shown hatched. These enclose the central recess 34 in a frame-like manner, already explained with reference to FIG. 3. Furthermore, the pressure equalization plate 10 has several recesses 37, which are not included in the view of FIG. 3. These each lie opposite one of the manifolds 36 in the end plate assembly 3, 4 and consequently also opposite one of the manifolds 36 in the unipolar plate 22. Consequently, the pressure equalization plate 10 does not obstruct the fluid transfer between these manifolds 36.

The positions of the recesses 30 in the form of countersunk holes are also shown. These are completely covered by the pressure equalization plate 10 and are not visible in a real top view as in FIG. 5, but are each indicated by a dashed line in FIG. 5.

As an optional feature, the current collector 20 has a web-like and/or elongated diversion section 21 which may, for example, extend in a groove of the end plate assembly 3, 4. As a further optional feature, the pressure equalization plate 10 has a covering section 23, which is located opposite to this diversion section 21. The diversion section 21 can be accommodated in a further recess 30 of the end plate assembly 3, 4. If this recess is designed with sufficient clearance, a guiding structure for the diversion section 21 can also be provided on the rear of the pressure equalization plate 10.

The pressure equalization plate 10 is made of or coated with an electrically insulating material so that it can touch the current collector 20 and for example its diversion section 21 without any risk of short-circuiting.

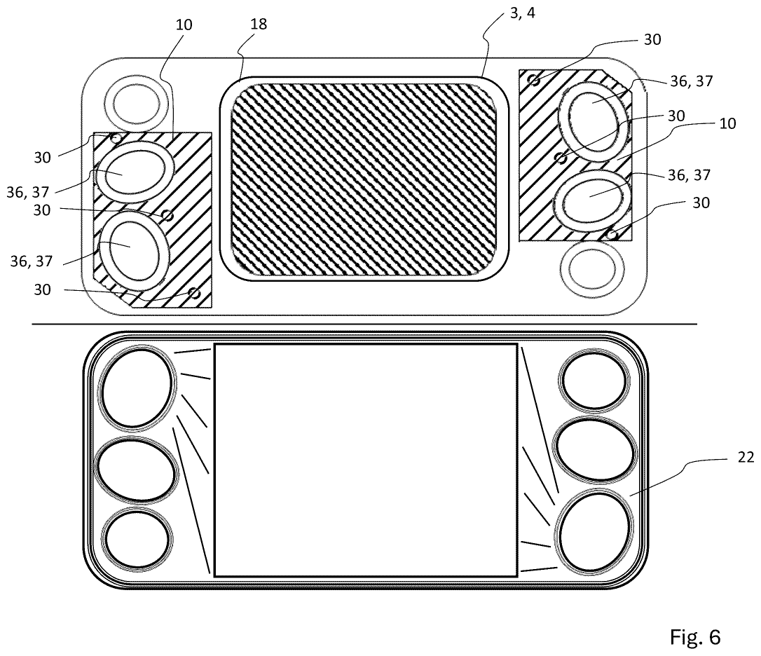

FIG. 6 shows a further embodiment in a view analogous to FIG. 5. In this case, the pressure equalization plate 10 is divided into two individual plates or two pressure equalization plates 10 are provided. Each of the pressure equalization plates 10 covers at least one and, in the example shown, several of the recesses 30. Together, the pressure equalization plates 10 cover all of these recesses 30. The dashed representations of the recesses 30 again correspond to an indication of their positions, although the recesses 30 are actually covered by the pressure equalization plates 10. Furthermore, the pressure equalization plates 10 again comprise recesses 37 to provide accessibility of the manifolds 36 of the end plate assembly 3, 4.

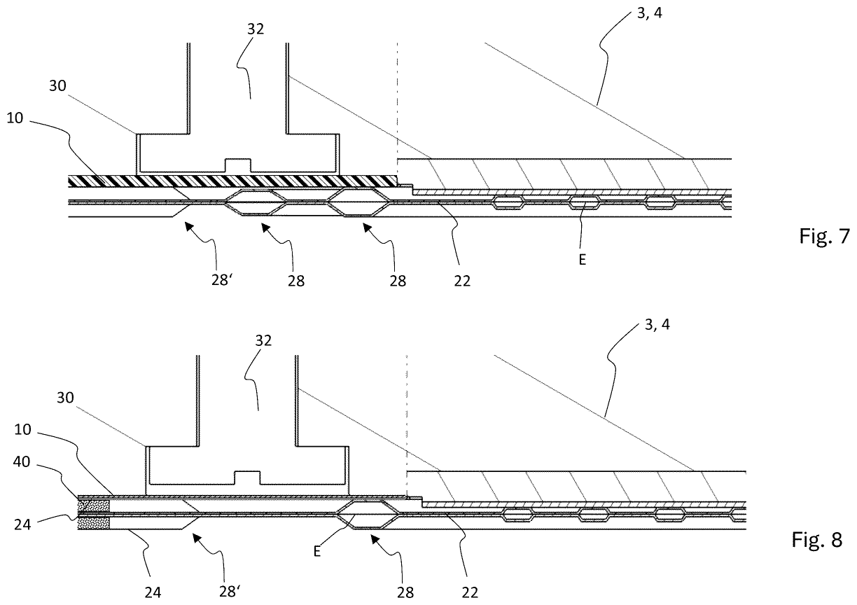

FIGS. 7 and 8 show further embodiments in views analogous to FIG. 3. The illustrations each correspond to a left-hand half of the illustration in FIG. 3, that is, are configured in the same way.

FIG. 7 again shows sealing beads 28 and a support element 28′ of the unipolar plate 22, which at least partially or completely face a recess 30 in the end plate assembly 3, 4. However, this recess 30 is covered by a solid region of a pressure equalization plate 10, which is only partially shown, so that the advantages described above are again achieved. This pressure equalization plate 10 is made of a plastic material and can therefore be designed with a greater wall thickness than an analogous metallic plate with an insulating layer.

In the example shown in FIG. 8, however, the pressure equalization plate 10 is made of a comparatively thin-walled sheet material, but is provided with an electrically insulating coating. Furthermore, an absorber element 40 is shown, which can in principle also be provided in all other embodiments, optionally also together with a support element 28′. The absorber element 40 forms a support structure or also a support element, which in the case shown is arranged within the unipolar plate 22 or between the inner sides of the separator plates 24 that face each other. In a manner known per se, the absorber element 40 can prevent excessive convergence of the separator plates 24 in the region of the corresponding sealing bead 28, since it supports the separator plates 24 against each other. At the same time, it can absorb impact energy in the event of excessive compression.

1. An electrochemical system having:
a stack comprising at least a plurality of electrochemical cells and separator plates,
at least one end plate assembly, and
at least one pressure equalization plate arranged between the stack and the end plate assembly,
wherein a side of the end plate assembly that faces the stack has at least a first recess and a first solid region of the pressure equalization plate lies opposite the first recess.

2. The electrochemical system according to claim 1,
wherein the pressure equalization plate completely covers the first recess.

3. The electrochemical system according to claim 1,
wherein the pressure equalization plate rests against the end plate assembly and/or against the stack.

4. The electrochemical system according to claim 1,
wherein the first recess occupies a proportion of less than 50% of an area of the side of the end plate assembly that faces the stack.

5. The electrochemical system according to claim 1,
wherein the first solid region of the pressure equalization plate faces a region of the stack that comprises at least one of the following sections:
at least one section of at least one sealing element of at least one separator plate for sealing a region of the separator plate; and
at least one section of at least one support element of at least one separator plate and/or of another support structure for supporting the separator plate and/or reducing a load on a sealing element of the separator plate.

6. The electrochemical system according to claim 1,
wherein the pressure equalization plate has a thickness of at least 0.075 mm and/or up to 2 mm.

7. The electrochemical system according to claim 1,
wherein a thickness of the pressure equalization plate is constant or at least is constant within 90% of a solidly-formed surface portion of the pressure equalization plate.

8. The electrochemical system according to claim 1,
wherein the pressure equalization plate is de-energized during operation of the electrochemical system.

9. The electrochemical system according to claim 1,
wherein the pressure equalization plate comprises a plastic material and/or a metallic material; and/or
wherein the pressure equalization plate is electrically insulated.

10. The electrochemical system according to claim 1,
wherein the pressure equalization plate extends in a frame-like manner around a central recess.

11. The electrochemical system according to claim 1,
wherein several pressure equalization plates are arranged to leave a central recess.

12. The electrochemical system according to claim 10,
wherein the central recess faces at least part of a region of the stack in which electrochemically active regions of the plurality of electrochemical cells are stacked on top of one another.

13. The electrochemical system according to claim 10,
wherein the central recess has an area with a size of at least 20% of a base area of the frame-shaped pressure equalization plate.

14. The electrochemical system according to claim 1,
wherein the first recess of the end plate assembly is formed as:
a counterbore for receiving a screw head or a section of another fastening element; or
a receiving region for a diversion section.

15. The electrochemical system according to claim 1,
wherein the pressure equalization plate has at least one recess, wherein the recess is opposite a first recess in at least one component of the stack and/or a second recess of the end plate assembly, wherein the second recess is configured as a channel opening for supplying fluid into the stack and/or for discharging fluid from the stack.
